(19) United States
(12) Patent Application Publication
(10) Pub. No.: US 2015/0379527 A1
(43) Pub. Date: Dec. 31, 2015

(54) DERIVATIVE NETWORK PROFILE FOR CUSTOMER INTERACTIONS

(71) Applicant: Avaya Inc., Santa Clara, CA (US)

(72) Inventors: David Skiba, Golden, CO (US); Peter Finney, Stevenage (GB); Andrew Maher, Wiesbaden (DE); Reinhard P. Klemm, Basking Ridge, NJ (US)

(21) Appl. No.: 14/319,019

(22) Filed: Jun. 30, 2014

(51) Int. Cl. G06Q 30/02; H04L 29/08; G06Q 50/00; G06F 17/30

(52) U.S. Cl. CPC G06Q 30/0201; G06F 17/30876; H04L 67/306; G06Q 50/01

(57) ABSTRACT

Derivative network profile is provided for determining a more complete picture of a customer on a social media website or websites for improved customer interactions. A customer may have a social media presence with any number of connections to other individuals, businesses, etc. As provided herein, the relevancy of those connections is determined within the context of a “seed” or business purpose. As a benefit, a customer who may share a substantial amount of information (e.g., funny videos, favorite sports teams, etc.) with a large pool of connections, may have a particular relationship identified (e.g., a more obscure relative who travels frequently) when a contact center is interacting with the customer with respect to the business purpose (e.g., providing travel-related services to the customer).

### FIELD OF THE DISCLOSURE

The present disclosure is generally directed toward determining a profile for a customer.

### BACKGROUND

Social media websites provide a source of customer information, such as interests, activities, and relationships. A contact center having an existing history with the customer may look to their own records as well as interactions of the customer on social media websites to gather additional information on the customer. For example, if an enterprise discovers a customer has social media connections (e.g., posts, comments, “likes,” etc.) with competing businesses, the enterprise may respond differently to an inquiry from the client than if the customer has no known connections to competitors.

While some insight may be provided by these techniques, it would be desirable to obtain a more complete picture of the customer.

### SUMMARY

It is with respect to the above issues and other problems that the embodiments presented herein were contemplated.

The insight provided by techniques of the prior art provide certain information, however, the information is limited as only an immediate network of interactions is considered.

With respect to certain embodiments provided herein, methods are provided to discover deeper insights otherwise hidden within derivative social interactions and context-based networks of communications. The methods may be triggered in response to a specific need or to determine what needs may exist. The resulting attributes may then be used as inputs into a customer profile, which may benefit inbound and outbound customer interactions.

In one embodiment, active discovery is performed as a constrained social media crawling process. The crawler starts out with customers who have shown activities in an initial set of social media channels. The crawler then explores each customer's interactions with other customers (either connected or unconnected) in personal social media channels and business channels and customer/business interactions, as well as other customer activities in additional business and organizational channels. The crawling may be guided and limited by predefined constraints, such as to avoid collecting/processing irrelevant information.

As a benefit of the resulting profile, the value of the customer to the business may be more accurately determined, such as by assigning and/or computing values for given attributes, such as an associated “likes,” interests, and needs related to a company or products. In a further embodiment, the value may be determined, in part, based on the sentiment of the customer's profile. For example, a positive sentiment towards a business may be associated with an advocate for the business and have a higher value. Conversely, a negative sentiment may have a lower value.

In one embodiment, systems and methods are disclosed to perform an active, constrained discovery of customer activities starting from an initial “seed” set of social media channels and additionally extend to conversations and activities which may include those outside the initial set of social media channels. The constraint can include search terms that must be matched by discovered posts, time limits, business verticals, degrees of separation in customer relationships, etc.

The discovered conversations may include customer/customer conversations as well as customer/business conversations and interactions, and the social media channels that the discovery extends to include both personal channels (e.g., a personal Facebook page) as well as business and organizational channels (e.g., the Twitter feed of a company).

In another embodiment, the profile is obtained by a process of iterative discovery based on interaction analysis. The discovery traces back interactions by the customer with others, which may be limited to attributes that meet predefined attributes such as topic, domain, time window, location, or other detectable features. Interactions are then mined based on a customer's complete network (e.g., following, followers, friends, and associated people where associated people would be those who interacted on the same sites/pages/brands as the customer).

The result is a set of interactions that may be analyzed to form a derivative network of interactions. For example, there may be 5,000 posts to look through when all of the interactions are brought together. The interactions would then be traversed or “walked through,” whereby interactions having a relevancy to a particular subject over a particular time period (e.g., international airline travel and occurred in the past week) may be preserved and irrelevant interactions may be discarded. The analysis can then reduce the network interactions, such as to 200 posts by 20 people. A second round of analysis may be performed to expand the network interactions and provide a reevaluation for domain and/or time attributes. The analysis may provide a set of network interactions resulting in a final set, such as 150 posts by 30 people.

The derivative profile network may then be analyzed based on the desired activity. If the call is inbound, then a summary could be provided for routing or an agent's display. For example, a display may indicate that the customer and, at least a portion of the derivative network, have traveled to Europe in the past week. For outbound opportunities, the attributes of “Paris,” “Rome,” “food,” and “travel” might emerge as active themes that could be used for a campaign of special travel deals.

In another embodiment, the social handles of similar customers, such as customers of the company, that have similar traits as the target customer, and their respective derivative profiles, may be used to gain insight into this particular customer.

Embodiments disclosed herein enable a contact center to compile a more comprehensive customer profile than would otherwise be possible with the information retrieved from only a fixed, a priori known set of social media channels. In addition, group profiles may be compiled that describes a group of people (e.g., close friends and relatives, club members, business associates, etc.) to which a given customer belongs. The group exhibits group dynamics and group behavior that might be relevant to a business. For group behavior, the system may determine the leader of the group and analyze the trending sentiment of the group as Positive/Neutral/Negative. An example of Positive sentiment would be the re-tweeting of a Twitter posts/#tags (advocacy as-is) and/or with an edited positive comment (+amplifying the initial post). Both profiles may allow a business to shape its future interactions with a customer in such a way that the business derives more value from the customer, either directly (selling additional/new products and services) or indirectly (increasing customer satisfaction and loyalty).

In one example, a customer profile might show that a customer who has posted on high-end automobile manufacturer's Facebook page frequently engages in discussions with friends on Facebook about a luxury goods company and that if one of these friends buys one of the high-end automobiles or a product from the luxury goods company, the others in the group may be included to follow suit. Both the automobile and luxury goods companies may then use this data in future interactions with the customer.

In another embodiment, the base concept embodied herein may be expanded and/or filtered to provide results based on domain, company, and/or topic, all of which may be derived from the direct social media data or customer social context. Additionally, a customer resource management (“CRM”) system may be utilized that provides data generated by within the business in the course of conducting transactions with its customers. For example, in an airline domain, data such as previous trips/locations, total spent/value to the airline, frequency of trips, upgrade purchases, etc., complement customer data derived from social networks to form a more complete picture of the customer's preferences, interests, inclinations, aspirations, plans, dislikes, complaints, etc. For example, an airline customer with a history of frugal spending on mostly short-haul trips with this airline may reveal on social media sites, through interactions with friends on Facebook, hotel Twitter feeds, and by following the Facebook page of Dubai a desire to go on a high-end vacation in Dubai. This knowledge may help the airline upsell the customer on a trip to Dubai during a future interaction.

The addition of the CRM data may cause the filtering aspect to become more important due to the volume and number of other connections and their respective data. One embodiment provided herein is to filter on attributes deemed to be important to a company. For example, items that are related to high income, luxury travel, European destinations will be retained for a transaction that is analyzed when high-value travel is important whereas less related posts relating to a lost bag are discarded or at least excluded from further consideration.

In one embodiment, a method is disclosed, comprising: accessing a seed content; selecting a root user having a presence on a social media website; deriving a number of secondary users as users of the social media website having at least one relationship with the root user; traversing the number of secondary users; collecting, in a collection, for ones of the number of secondary users having user provided content associated with the seed content, the user provided content analyzing the collection; and presenting the analyzed collection to an agent of a contact center to support an interaction between the agent and the root user.

In another embodiment, a system is disclosed, comprising: a processor; a memory; and a communication interface; wherein the processor is operable to: access a seed content determined in accord with a business objective of a contact center; select a root user having a presence on a social media website; causing the communication interface to access the social media website; deriving a number of secondary users as users of the social media website having a relationships with the root user; traversing the number of secondary users; and collecting in a collection, for ones of the number of secondary users having user provided content associated with the seed content, the user provided content.

In still another embodiment, a non-transitory computer readable medium is disclosed with instructions thereon that when read by the computer cause the computer to perform: accessing a seed content determined in accord with a business objective of a contact center; selecting a root user having a presence on a social media website; and deriving a number of secondary users as users of the social media website having a relationships with the root user; traversing the number of secondary users; and collecting in a collection, for ones of the number of secondary users having user provided content associated with the seed content, the user provided content.

The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

The terms “determine,” “calculate,” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the disclosure is described in terms of exemplary embodiments, it should be appreciated that other aspects of the disclosure can be separately claimed.

### BRIEF DESCRIPTION OF THE DRAWINGS

The present disclosure is described in conjunction with the appended figures:

FIG. 1 depicts a communication system in accordance with at least some embodiments of the present disclosure;

FIG. 2 depicts a relationship tree in accordance with embodiments of the present disclosure;

FIG. 3 depicts a derivative network profile in accordance with embodiments of the present disclosure;

FIG. 4 depicts a process for determining a derivative network profile in accordance with embodiments of the present disclosure; and

FIG. 5 depicts a second process for determining a derivative network profile in accordance with embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

The identification in the description of element numbers without a subelement identifier, when a subelement identifiers exist in the figures, when used in the plural, is intended to reference any two or more elements with a like element number. A similar usage in the singular, is intended to reference any one of the elements with the like element number. Any explicit usage to the contrary or further qualification shall take precedence.

The exemplary systems and methods of this disclosure will also be described in relation to analysis software, modules, and associated analysis hardware. However, to avoid unnecessarily obscuring the present disclosure, the following description omits well-known structures, components and devices that may be shown in block diagram form, and are well known, or are otherwise summarized.

For purposes of explanation, numerous details are set forth in order to provide a thorough understanding of the present disclosure. It should be appreciated, however, that the present disclosure may be practiced in a variety of ways beyond the specific details set forth herein.

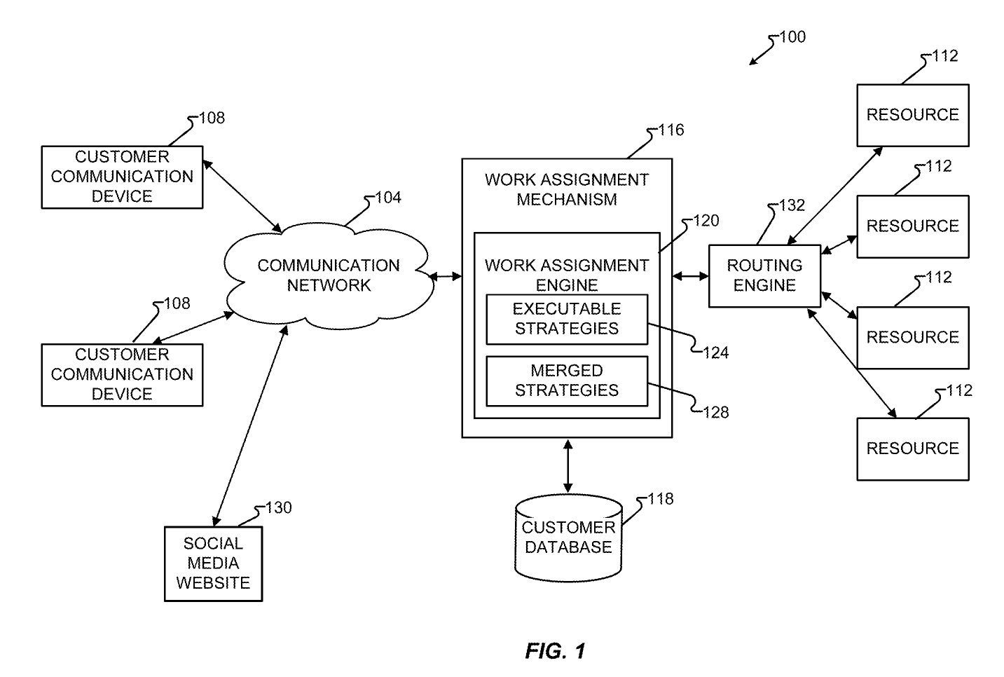

With reference now to FIG. 1, communication system 100 in accordance with at least some embodiments of the present disclosure. The communication system 100 may be a distributed system and, in some embodiments, comprises a communication network 104 connecting one or more communication devices 108 to a work assignment mechanism 116, which may be owned and operated by an enterprise administering a contact center in which a plurality of resources 112 are distributed to handle incoming work items (in the form of contacts) from customer communication devices 108. Additionally, social media website 130 may be utilized to provide one means for a resource 112 to receive and/or retrieve contacts and connect to a customer of a contact center. Customers may utilize their respective customer communication device 108 to send/receive communications utilizing social media website 130.

In accordance with at least some embodiments of the present disclosure, the communication network 104 may comprise any type of known communication medium or collection of communication media and may use any type of protocols to transport messages between endpoints. The communication network 104 may include wired and/or wireless communication technologies. The Internet is an example of the communication network 104 that constitutes and Internet Protocol (IP) network consisting of many computers, computing networks, and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, a Voice over IP (VoIP) network, a cellular network, and any other type of packet-switched or circuit-switched network known in the art. In addition, it can be appreciated that the communication network 104 need not be limited to any one network type, and instead may be comprised of a number of different networks and/or network types. As one example, embodiments of the present disclosure may be utilized to increase the efficiency of a grid-based contact center. Examples of a grid-based contact center are more fully described in U.S. patent application Ser. No. 12/469,523 to Steiner, the entire contents of which are hereby incorporated herein by reference. Moreover, the communication network 104 may comprise a number of different communication media such as coaxial cable, copper cable/wire, fiber-optic cable, antennas for transmitting/receiving wireless messages, and combinations thereof

The communication devices 108 may correspond to customer communication devices. In accordance with at least some embodiments of the present disclosure, a customer may utilize their communication device 108 to initiate a work item, which is generally a request for a processing resource 112. Illustrative work items include, but are not limited to, a contact directed toward and received at a contact center, a web page request directed toward and received at a server farm (e.g., collection of servers), a media request, an application request (e.g., a request for application resources location on a remote application server, such as a SIP application server), and the like. The work item may be in the form of a message or collection of messages transmitted over the communication network 104. For example, the work item may be transmitted as a telephone call, a packet or collection of packets (e.g., IP packets transmitted over an IP network), an email message, an Instant Message, an SMS message, a fax, and combinations thereof. In some embodiments, the communication may not necessarily be directed at the work assignment mechanism 116, but rather may be on some other server in the communication network 104 where it is harvested by the work assignment mechanism 116, which generates a work item for the harvested communication, such as social media server 130. An example of such a harvested communication includes a social media communication that is harvested by the work assignment mechanism 116 from a social media network or server. Exemplary architectures for harvesting social media communications and generating work items based thereon are described in U.S. patent application Ser. Nos. 12/784,369, 12/706,942, and 12/707,277, filed Mar. 20, 1010, Feb. 17, 2010, and Feb. 17, 2010, respectively, each of which are hereby incorporated herein by reference in their entirety.

In another embodiment, customer database 118 may represent one or more private data storage devices or systems accessible to a contact center operating contact center 100.

The format of the work item may depend upon the capabilities of the communication device 108 and the format of the communication. In particular, work items are logical representations within a contact center of work to be performed in connection with servicing a communication received at the contact center (and more specifically the work assignment mechanism 116). The communication may be received and maintained at the work assignment mechanism 116, a switch or server connected to the work assignment mechanism 116, or the like until a resource 112 is assigned to the work item representing that communication at which point the work assignment mechanism 116 passes the work item to a routing engine 132 to connect the communication device 108 which initiated the communication with the assigned resource 112.

Although the routing engine 132 is depicted as being separate from the work assignment mechanism 116, the routing engine 132 may be incorporated into the work assignment mechanism 116 or its functionality may be executed by the work assignment engine 120.

In accordance with at least some embodiments of the present disclosure, the communication devices 108 may comprise any type of known communication equipment or collection of communication equipment. Examples of a suitable communication device 108 include, but are not limited to, a personal computer, laptop, Personal Digital Assistant (PDA), cellular phone, smart phone, telephone, or combinations thereof. In general each communication device 108 may be adapted to support video, audio, text, and/or data communications with other communication devices 108 as well as the processing resources 112. The type of medium used by the communication device 108 to communicate with other communication devices 108 or processing resources 112 may depend upon the communication applications available on the communication device 108.

In accordance with at least some embodiments of the present disclosure, the work item is sent toward a collection of processing resources 112 via the combined efforts of the work assignment mechanism 116 and routing engine 132. The resources 112 can either be completely automated resources (e.g., Interactive Voice Response (IVR) units, processors, servers, or the like), human resources utilizing communication devices (e.g., human agents utilizing a computer, telephone, laptop, etc.), or any other resource known to be used in contact centers.

As discussed above, the work assignment mechanism 116 and resources 112 may be owned and operated by a common entity in a contact center format. In some embodiments, the work assignment mechanism 116 may be administered by multiple enterprises, each of which has their own dedicated resources 112 connected to the work assignment mechanism 116.

In some embodiments, the work assignment mechanism 116 comprises a work assignment engine 120 which enables the work assignment mechanism 116 to make intelligent routing decisions for work items. In some embodiments, the work assignment engine 120 is configured to administer and make work assignment decisions in a queueless contact center, as is described in U.S. patent application Ser. No. 12/882,950, the entire contents of which are hereby incorporated herein by reference. In other embodiments, the work assignment engine 120 may be configured to execute work assignment decisions in a traditional queue-based (or skill-based) contact center.

The work assignment engine 120 and its various components may reside in the work assignment mechanism 116 or in a number of different servers or processing devices. In some embodiments, cloud-based computing architectures can be employed whereby one or more components of the work assignment mechanism 116 are made available in a cloud or network such that they can be shared resources among a plurality of different users.

In one embodiment, a message is generated by customer communication device 108 and received, via communication network 104, at work assignment mechanism 116. The message received by a contact center, such as at the work assignment mechanism 116, is generally, and herein, referred to as a “contact.” Routing engine 132 routes the contact to at least one of resources 112 for processing.

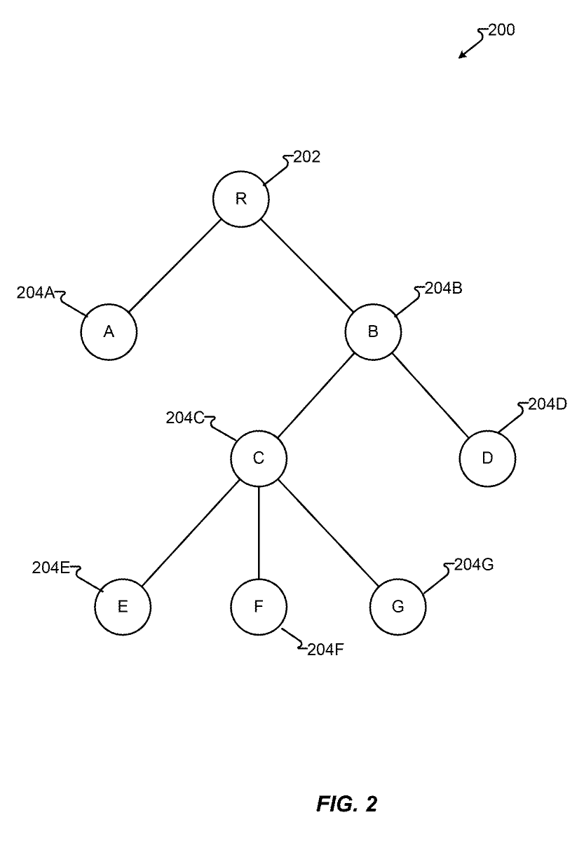

With reference now to FIG. 2, a relationship tree 200 will be described for determining a derivative network profile in accordance with embodiments of the present disclosure. Tree 200 may be embodied as any form of relationship map whereby one node is connected to other nodes, those nodes are connected to still other nodes, and so on. Tree 200 may be a single node, such as when root user 202 has no relationships, to a substantial number of first-tier relationships. Similarly, one or more of the secondary users forming a first-tier with root user 202, namely secondary users 204A, 204B, may in turn have zero or more relationships with the third-tier nodes (e.g., secondary users 204C, 204D), and similarly for any fourth-tier nodes and beyond. In some embodiments, the data of the relationship tree 200 may be maintained in a graph database as a collection of nodes and relationships.

Root user 202 represents a customer of a contact center and a root node of relationship tree 200. It should be noted that other topographies other than tree structures may be utilized without departing from the embodiments described herein. The customer representing root user 202 has direct and/or indirect relationships with a number of other individuals, organizations, businesses, associations, etc. identified as secondary users 204. Two first-level relationships between root user 202 and secondary users 204A and 204B are illustrated. Secondary user 204B has relationships with secondary users 204C and 204D. Secondary user 204C has relationships with secondary users 204E, 204F, and 204G.

The relationship binding root user 202 to any one or more secondary users 204 is variously embodied. For example, the relationship may be one of familiarity (e.g., links, friends, connections, etc.). The relationship may be one of commonality with respect to a business, domain, topic, or private data (e.g., customer resource management data or “CRM”). Private data from CRM may be accessed from customer database 118. For example, tree 200 may illustrate customers who are customers of a business. In other examples, tree 200 may represent customers having complaints about a business or product of a business. In yet another example, tree 200 may represent a customer who is traveling and fellow travelers, secondary users 204, who are stuck at a particular airport after a flight has been cancelled.

In one embodiment, tree 200 is relationship on a social media website 130 that is traversed with respect to a seed content. The seed content may be identified as a particular topic, phrase, identifier, or other aspect of interest to a particular business. For example, an airline might consider the seed to be “travel,” “air travel,” “international travel,” “luxury vacations,” “business trips,” etc. Another airline may be interested in customers who are, or are considering, activities that the customer is considering that they be able to supplant with air travel, such as, “family vacation,” “road trip,” “train travel,” “seeing family,” etc. In another embodiment, the seed content may be based on a particular social media website 130. For example, a user who posted a comment, or even simply has an account on a particular website known to have relevant content (e.g., “I_hate_xyz.com,” “FanOfXYZ.com,” etc.) may be relevant to the seed content associated with XYZ Airlines. Similarly, posts and/or users utilizing a more general but related websites (LonelyPlanet, Fodors, etc.) may be considered relevant seed content.

In another embodiment, root user 202 has a relationship with secondary user 204A and 204B. Secondary user 204A has no user provided content related to the seed. Accordingly, any second-tier relationships, that is relationships wherein secondary user 204A has a relationship with a node that does not include root user 202 may be omitted from further searching. In other embodiments, such relationships are explored until some limit has been reached. The limit may be one of volume of user provided content gleaned from tree 200, number of tiers from root user 202, or other aspect of the search which may be selected as a matter of design choice. Secondary user 204B has a relationship with root user 202 in terms of the seed content. For example, secondary user 204B may have a message, post, “like,” etc. regarding travel. Secondary user 204C, being associated with root user 202 only via the intermediary of secondary user 204B may have more content related to the seed. For example, secondary user 204B may have recently posted on their social media page, content related towards international travel.

Secondary users 204D, 204E, 204F, and 204G may have no content on their social media page, no relevant/timely content, or otherwise not be of interest. For example, secondary users 204E, 204F, and 204G may each have extensive travel content on their respective social media pages, however, the content may be older than a date previously determined to be relevant. Therefore, a contact center may either not collect or filter out the stale content.

In another embodiment, social media website 130 may be two or more social media websites and may be represented by tree 200. For example, the relationship between root user 202 and secondary user 204B may be that root user 202 has “liked” a post from a business on Facebook and that post had a link to and/or from a Tweet on the business's Twitter account, which was “retweeted” by secondary user 204B. In another example, a user (root user 202 and/or one or more secondary users 204) have a known profile on two or more social media websites 130.

In another embodiment, the relationship between nodes on tree 200 may be unknown or at least not readily apparent to root user 202. For example, root user 202 may post, “Flight cancelled. Stuck in Atlanta.” A seed value, such as “stuck in Atlanta” may be created by a business, such as an airline, passenger train, hotels, limousine services, or other business that may be interested in its own customers or potential new customers who have had their flights cancelled. Tree 200 may be traversed and, secondary user 204E may have “checked in” at a restaurant in the Atlanta-Hartsfield airport and posted, “. . . at least Terminal B has the XYZ restaurant. Great place.” Accordingly, an interaction with root user 202 may then incorporate knowledge gained from secondary user 204E, such as directing them to the XYZ restaurant. As a further example, the relationship may be utilized (e.g., “Your friend Bob's co-worker Alice is also stuck in Atlanta.”).

An enterprise wishing to provide a greater degree of customer service to root user 202 may benefit from the associations provided in tree 200 when interacting with root user 202. For example, root user 202 may be contemplating an international vacation may be presented with a post or summary from one or more secondary users 204 (e.g., “Your friend Bob's co-worker Alice has some great pictures of her trip to Ireland.”). In another example, a pool of secondary users 204 are analyzed where it is discovered that thirty secondary users 204 posted content related to travel, fifteen secondary users 204 posted content related to international travel, and ten posted content regarding travel to Barcelona. An agent interacting with the customer may be presented with such information for use with the customer, such as to mention a special promotions or incentive, regarding travel to Spain.

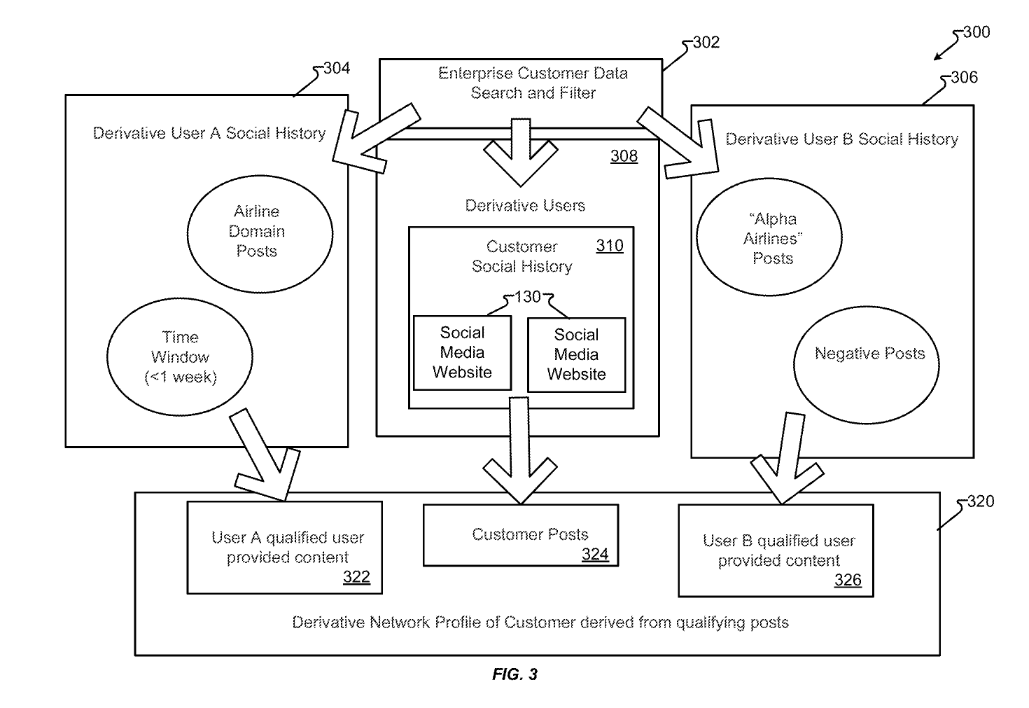

With reference now to FIG. 3, derivative network profile 300 will be described accordance with embodiments of the present disclosure. In one embodiment, enterprise customer data search and filter 302 searches for connections, which may be limited to internal customer data, such as from customer database 130. Results may be filtered out and/or not collected if outside the seed, lack of value to the business, or interactions on social media website 130 or other channel.

Derivative users 308 identifies users (e.g., root user 202, secondary users 204, etc.) having a qualified user provided content and/or interaction with a particular customer (e.g., root customer 202). For example, users having a qualification (e.g., customers, customers who purchased a particular product, customers who are likely to purchase a particular product, etc.) and/or a specific user (e.g., root user 202) and related secondary users 204 and/or user provided content that is germane to seed content (e.g., “travel”) previously determined by the business.

Customer social history comprises the direct content provided by a particular user on one or more social media websites 130. User provided content includes, but is not limited to, original content authored and provided by the user, such as text, audio, video, images, etc. User provided content may also include embellishments provided with respect to other content, which may further include the user's own previously provided content (e.g., rating, thumbs-up, “like,” comment, etc.) as well as propagation of content (e.g., share, re-tweet, etc.) to make the content available, or more likely to be seen, by other users. User provided content may become stale. In another embodiment, only the user provided content that is within a period of time previously determined to be relevant is utilized for further processing. Content that is stale may be excluded from processing or collected and filtered-out from further processing.

Derivative user A social history 304 and derivative user B social history 304 is then identified and processed. Qualifying content (e.g., within the seed content, type of interaction with another user, etc.) Is then collected in collection 320 having user A qualified posts 322, user B qualified user provided content 326 and customer user provided content 324.

In another embodiment, collection 320 is analyzed periodically, predictively, and/or in response to an action, such as initiation of an action between root user 202 and a contact center.

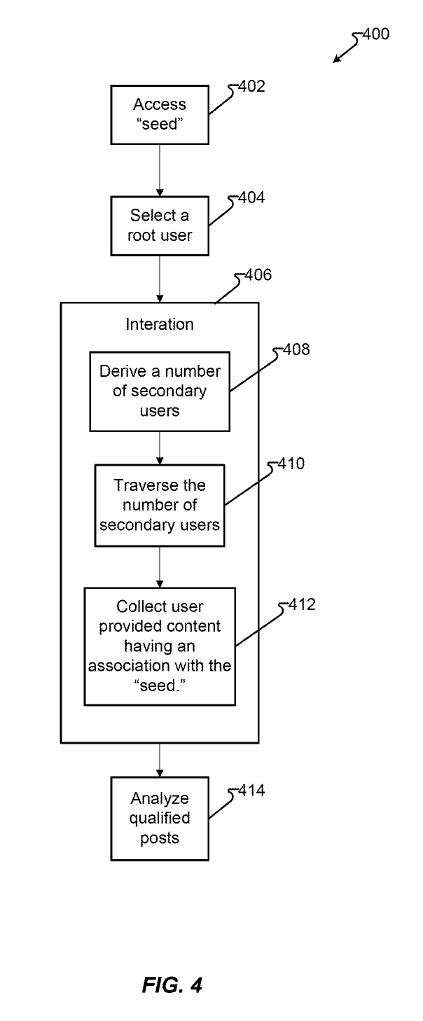

With reference now to FIG. 4, process 400 will be described for determining a derivative network profile in accordance with embodiments of the present disclosure. In one embodiment, step 402 accesses a seed content. The seed may be a particular topic, domain, CRM data, user, website, or other attribute determined by an entity to be of relevance. Step 404 selects a root user. Step 404 may be performed upon demand, such as when the root user initiates contact with a contact center, periodically, and/or on demand. In another embodiment, step 404 selects a plurality of users.

Step 406 performs an iteration to populate a collection of qualified posts. The iteration may be performed until a previously determined threshold value of an attribute of the result. For example, an enterprise may try to discover 50 posts from the derivative network of a user that are associated with the seed. If the user has a substantial number of connections, it may be possible to populate the connection by only traversing the first-tier connections, or even a portion of the first-tier connections. In another embodiment, several tiers are traversed before reaching the threshold number of posts. In still another embodiment, a threshold number of tiers are traversed without regard to the number of qualified posts gleaned from the traversal, such as when no or only a limited number of the desired number of qualified posts are discovered. For example, a user selected in step 404 may be associated with “SCUBA diving” as the seed. However, the user and their network, including derivative network, may have no experience or prior interest in SCUBA diving.

Iteration step 406 includes steps 408, 410, and 412. Step 408 derives a number of secondary users (e.g., secondary users 204) for the associated root user selected in step 404. Step 410 traverses the number of secondary users. Step 412 then collects qualified user provided content from the traversed number of secondary users. Iteration step 406 may then be repeated, whereby a secondary user is selected as the root user, until a threshold limit is reached. Step 414 then analyzes the collection and may further present the results to an agent of a contact center interacting with the root user.

In another embodiment, the criteria matching user provided content to the seed, for collection by step 412, is determined in part on the number of iterations. Therefore, while the user provided content of a secondary user 204 may be collected if they are in a lower-tier relationship with root user 202, such content may not be collected if the secondary tier user 204 is in a higher-tier relationship. For example, a seed of “international travel” may be weakly correlated for first-tier relationships (e.g., “I wish I was there. <picture of a beach>”, “The airline industry sure has some issues,” etc.). Moving to the second tier relationships, the correlation requirement is increased (e.g., “I wish I was in Hawaii.” “Traveling across the ocean—no thanks”) The third-tier relationships require an even stronger correlation with the seed (e.g., “Here are pictures of my trip to Athens.” “Thinking about London next year.” “Tickets prices to Asia just went up.” etc.).

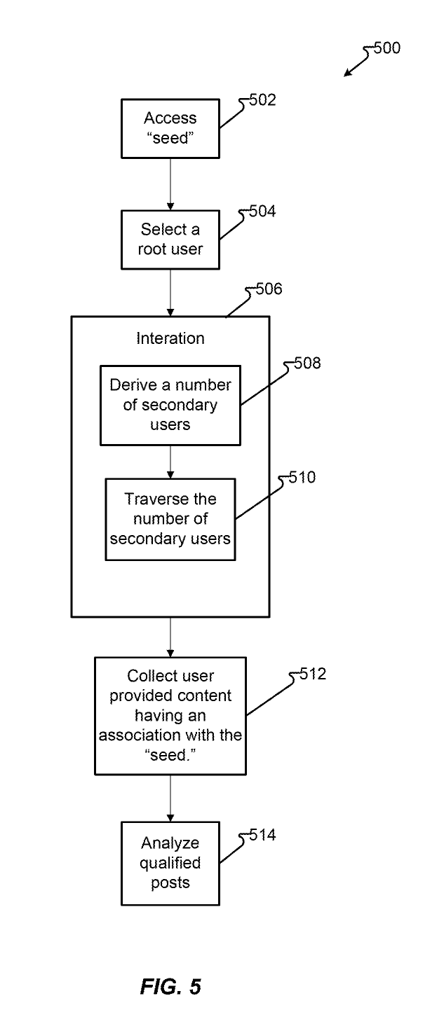

With reference now to FIG. 5, process 500 will be described for determining a derivative network profile in accordance with embodiments of the present disclosure. Step 502 accesses the seed and step 504 selects a root user. Iteration 506 comprises steps 508 and 510. Iteration 506 may be performed a number of times, such as until a previously determined target attribute of the collection is reached, such as, until the distance (e.g., in nodes) from the remaining secondary users to the root user selected in step 504 is reached and/or until no relevant user provided contend is determined, or a combination thereof.

With the secondary users traversed, step 512 collects the user provided content associated with the seed. In another embodiment, the content is collected in conjunction with traversal step 510.

The traversal of the secondary users may identify as many other secondary users as can or will be traversed, including the secondary users thereto, to provide the gather user provided content for later filtering and/or analysis. In another embodiment, a limit may be placed on the depth of the traversal based on relevant user provided content found. For example, step 508 may derive secondary user 204B in a first iteration 506 for traversal 510. In a second iteration 506, step 508 derives users 204C, 204D. If a limit of two were to be placed on the depth of the traversal associated with the absence of user provided content associated with the seed and user 204B and user 204C had no relevant user provided content, integration 506 may end and processing proceed to step 512. As a result, traversal of users 204E, 204F, and 204G would be omitted. The selection of such a limit may be determined as a matter of design choice and range from infinite (e.g., every connection is traversed to exhaustion) or, as illustrated above, until a previously determined limit is reached.

Such a limit may be derived dynamically based on a degree of relevancy and/or distance from the root user. In one example, all first and second relationships (e.g., nodes, 204A, 204B, 204C, 204D for root user 202) may be traversed and optionally their user provided content obtained, such as for later filtering/analysis, regardless of the determination of any relevant user provided content. However, going to a third level (e.g., nodes 204E, 204F, 204G) may require at least some user provided content associated with the seed. As the distance from root user 202 increases the relevancy may become increasingly strict. For example, if the seed was, “first class travel to Europe” the first and second level nodes (e.g., 204A, 204B, 204C, 204D) may be traversed without regard to their user provided content. The third-level nodes (204E, 204F, 204G) may require at least some relevant user provided content (e.g., “I would like to get away next weekend”). A fourth-level node (not shown) may require increased relevancy (e.g., “My flight to Mexico City was terrible.”). Optionally, at some level, an exact or nearly exact match must be required.

As a particular node is determined to be devoid of relevant user provided content, a number of additional levels may be traversed. For example, node 204B may have no relevant content but the next level (nodes 204C, 204D) may be traversed in an effort to discover a node that does have such a relevant content. The number of levels traversed from a node wherein the node has no relevant user provided content, is selected as a matter of design choice such as to fulfill a particular degree of thoroughness in view of the processing efforts and/or relevancy of continuing the traversal.

Step 514 then analyzes the qualified posts collected from the user provided content in step 512. Optionally, filtering may occur to reduce the processing and/or memory associated with user provided content that was gathered but determined not to be associated with the seed.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU) or logic circuits programmed with the instructions to perform the methods (FPGA). These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A method, comprising:
accessing a seed content;
selecting a root user having a presence on a social media website;
deriving a number of secondary users as users of the social media website having at least one relationship with the root user;
traversing the number of secondary users;
collecting, in a collection, for ones of the number of secondary users having user provided content associated with the seed content, the user provided content
analyzing the collection; and
presenting the analyzed collection to an agent of a contact center to support an interaction between the agent and the root user.

2. The method of claim 1, wherein the seed content is determined in accord with a business objective of a contact center.

3. The method of claim 1, wherein the step of analyzing, further comprises the step of filtering the collection to remove an entry void of an attribute previously determined to be relevant to the business objective.

4. The method of claim 1, further comprising:
accessing a target attribute of the collection; and
wherein the steps of deriving, traversing, collecting, analyzing, and presenting are performed for ones of the number of secondary users until an associated attribute of the collection satisfies the target attribute.

5. The method of claim 1, wherein the user provided content is within the seed content upon determining the secondary content is associated with the seed content in at least one of topic, domain, and company.

6. The method of claim 1, wherein the user provided content is within the seed content upon determining the secondary content is associated with the seed content in private data to the enterprise.

7. The method of claim 1, wherein collecting further comprises,
collecting the relationship between the root user and ones of the number of secondary users, for ones of the number of secondary users having user provided content associated with the seed content.

8. The method of claim 1, wherein the relationship is unknown to at least one of the root user and a related one of the number of secondary users.

9. The method of claim 1, wherein the social media website is a first social media website for the root user and a second social media website for at least one of the number of secondary users.

10. The method of claim 1, wherein the root user is a group of root users having a previously identified association.

11. A system, comprising:
a processor;
a memory; and
a communication interface;
wherein the processor is operable to:
access a seed content determined in accord with a business objective of a contact center;
select a root user having a presence on a social media website;
causing the communication interface to access the social media website;
deriving a number of secondary users as users of the social media website having a relationships with the root user;
traversing the number of secondary users; and
collecting in a collection, for ones of the number of secondary users having user provided content associated with the seed content, the user provided content.

12. The system of claim method of claim 11, further comprising:
a presentation device associated with an agent of a contact center; and
wherein the processor being further operable to analyze the collection and cause
the presentation device to present the analyzed collection to an agent of a contact center to support an interaction between the agent and the root user.

13. The system of claim 12, further comprising:
causing the processor to access a target attribute of the collection and performing the steps of accessing, selecting, causing, deriving, traversing, and collecting for ones of the number of secondary users until an associated attribute of the collection satisfies the target attribute.

14. The system of claim 11, wherein the user provided content is within the seed content upon determining the secondary content is associated with the seed content in at least one of topic, domain, and company.

15. The system of claim 11, further comprising:
a customer resource management record; and
wherein the processor is operable to access the customer resource management record and determine whether the secondary content is associated with the seed content in the customer resource management record.

16. A non-transitory computer readable medium with instructions thereon that when read by the computer cause the computer to perform:
accessing a seed content determined in accord with a business objective of a contact center;
selecting a root user having a presence on a social media website; and
deriving a number of secondary users as users of the social media website having a relationships with the root user;
traversing the number of secondary users; and
collecting in a collection, for ones of the number of secondary users having user provided content associated with the seed content, the user provided content.

17. The non-transitory medium of claim 16, further comprising instructions to perform:
analyzing the collection; and
presenting the analyzed collection to an agent of a contact center to support an interaction between the agent and the root user.

18. The non-transitory medium of claim 16, wherein the step of analyzing, further comprises instructions to perform the step of filtering the collection to remove an entry void of an attribute previously determined to be relevant to the business objective.

19. The method of claim 1, wherein the user provided content is within the seed content upon determining the secondary content is associated with the seed content in at least one of topic, domain, and company.

20. The method of claim 1, wherein the user provided content is within the seed content upon determining the secondary content is associated with the seed content in private data to the enterprise.
